(19) United States
(12) Patent Application Publication
(10) Pub. No.: US 2024/0195164 A1
(43) Pub. Date: Jun. 13, 2024

(54) DC POWER DISTRIBUTION SYSTEM, CONTROL APPARATUS, OPERATION STATE DETERMINATION METHOD AND PROGRAM

(71) Applicant: NIPPON TELEGRAPH AND TELEPHONE CORPORATION, Tokyo (JP)

(72) Inventors: Naoki HANAOKA, Tokyo (JP); Toru TANAKA, Tokyo (JP); Naomichi NAKAMURA, Tokyo (JP); Yuji HIGUCHI, Tokyo (JP)

(21) Appl. No.: 18/554,310

(22) PCT Filed: Apr. 15, 2021
(86) PCT No.: PCT/JP2021/015633

§ 371 Date: Oct. 6, 2023

(51) Int. Cl. H02H 1/00; H02H 7/22

(52) U.S. Cl. CPC H02H 1/0007; H02H 7/22

(57) ABSTRACT

To provide a DC power distribution system that distributes power from a power supply device to a load device via a distribution network, the DC power distribution system including: a measuring instrument that is provided in the distribution network; and a control device that includes a determination unit that acquires, through optical fiber, a voltage value and a current value measured by the measuring instrument, and determines an operation state in the DC power distribution system on the basis of a waveform indicating a change in the voltage value and a waveform indicating a change in the current value.

### TECHNICAL FIELD

The present invention relates to a technology for detecting a fault such as a ground fault or a short circuit that has occurred in a power distribution system.

### BACKGROUND ART

In a power distribution system, it is necessary to take an action such as stopping power distribution from a power supply device when a fault such as a ground fault or a short circuit is detected.

As an example of a device for detecting a fault such as a ground fault or a short circuit, a distance relay (e.g., a mho relay described in Non Patent Literature 1) is used at a sending end of an AC substation or the like. The distance relay operates when a function of a ratio of a voltage to a current becomes equal to or less than a predetermined value, with the voltage and the current as input quantities. This ratio is called the impedance seen by the relay.

Meanwhile, in communication buildings, data centers, and the like, high-voltage DC power distribution systems have been introduced for the purpose of reducing power loss of the entire system and achieving energy saving. A high-voltage DC power distribution system distributes power at a high voltage such as 380 V, for example.

### CITATION LIST

### Non Patent Literature

Non Patent Literature 1: Glossary (22nd Theme: Mho Relay), Journals of the Institute of Electrical Engineers of Japan, B (Journals in Electricity and Energy), Vol. 132 (2012), No. 8 https://www.jstage.jst.go.jp/article/ieejpes/132/8/132_NL8_6/_pdf

### SUMMARY OF INVENTION

### Technical Problem

A direct current used in a high-voltage DC power distribution system has no reactance component, and thus a distance relay such as the mho relay described in Non Patent Literature 1 cannot be used. In addition, there is no distance relay for distributing DC power at a high voltage such as 380 V in the market.

Although there are conventional technologies for detecting a fault such as a ground fault or a short circuit that has occurred in a DC power distribution system, accuracy of the detection is not sufficient, for example, an event that is not a fault is erroneously detected as a fault.

The conventional technologies use a metal wire for signal transmission, and erroneous detection may occur due to the influence of noise. In addition, the conventional technologies are accompanied by a long delay time in monitoring control of equipment using a metal wire, a photocoupler, or the like. It has therefore been difficult to apply a fault detection system between locations several kilometers away from each other, for example.

It is an object of the present invention to provide a technology that allows for quick and accurate detection of a fault in a DC power distribution system.

### Solution to Problem

The disclosed technology provides a DC power distribution system that distributes power from a power supply device to a load device via a distribution network, the DC power distribution system including:
a measuring instrument that is provided in the distribution network; and
a control device that includes a determination unit that acquires, through optical fiber, a voltage value and a current value measured by the measuring instrument, and determines an operation state in the DC power distribution system on the basis of a waveform indicating a change in the voltage value and a waveform indicating a change in the current value.

### Advantageous Effects of Invention

According to the disclosed technology, it is possible to quickly and accurately detect a fault in a DC power distribution system.

### BRIEF DESCRIPTION OF DRAWINGS

FIG. 1 is a diagram illustrating Configuration Example 1 of a DC fault detection system according to an embodiment of the present invention.

FIG. 2 is a diagram illustrating a configuration example of connection with an optical fiber.

FIG. 3 is a diagram illustrating an example of a detection value and a determination result.

FIG. 4 is a diagram illustrating Configuration Example 2 of the DC fault detection system according to the embodiment of the present invention.

FIG. 5 is a diagram illustrating a configuration example of a control device.

FIG. 6 is a diagram illustrating a configuration example of the control device.

FIG. 7 is a diagram illustrating a configuration example of a learning device.

FIG. 8 is a diagram illustrating a hardware configuration example of a device.

FIG. 9 is a flowchart for illustrating an operation of the control device.

FIG. 10 is a flowchart for illustrating the operation of the control device.

FIG. 11 is a diagram illustrating an example of a waveform.

FIG. 12 is a diagram illustrating an example of a waveform.

### DESCRIPTION OF EMBODIMENTS

Hereinafter, an embodiment (the present embodiment) of the present invention will be described with reference to the drawings. The embodiment described below is merely an example, and the embodiment to which the present invention is applied is not limited to the following embodiment.

A DC power distribution system according to the present embodiment is assumed to be a high-voltage DC power distribution system (hereinafter referred to as the DC power distribution system) that distributes power with direct current of 380 V. However, “380 V” is an example. The present invention is applicable not only to a high-voltage DC power distribution system but also to DC power distribution systems in general.

### System Configuration Example 1

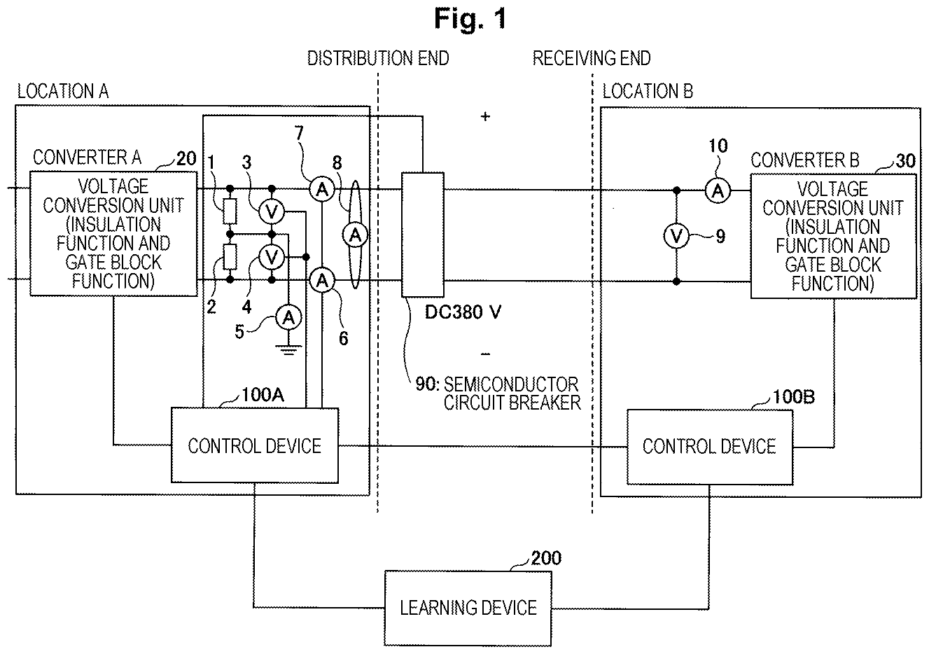

FIG. 1 illustrates Configuration Example 1 of the DC power distribution system according to the present embodiment. Configuration Example 1 shows a system that distributes power from Location A to Location B with direct current. In addition, distribution of power from Location B to Location A is also possible. That is, power can be distributed in both directions. Examples of Location A and Location B include buildings such as communication buildings, but are not limited to buildings. The distance between Location A and Location B is not particularly limited, but may be several kilometers or more in the present embodiment.

In Configuration Example 1, Location A is provided with a converter A 20, and Location B is provided with a converter B 30. Each converter is a DC/DC converter, and is a device that converts the magnitude of a DC voltage. The converter A 20 may be an AC/DC converter. As illustrated in the drawing, each converter includes a voltage conversion unit, and has an insulation function and a gate block function.

The converter A 20 in Location A and the converter B 30 in Location B are connected by a distribution network (positive distribution line and negative distribution line), and a DC current of 380 V is distributed from the converter A 20 in Location A to the converter B 30 in Location B. The converter B 30 is an example of a load device that receives distributed power. In Location B, one or more load devices (e.g., servers) are connected downstream of the converter B 30. The “load device” includes the converter B 30 and a device such as a server to which power is supplied from the converter B 30. The “DC power distribution system” includes the converter A 20, the distribution network, and the load device.

In the example illustrated in FIG. 1, a semiconductor circuit breaker 90 is provided outside Location A, and the semiconductor circuit breaker 90 can break a circuit between Location A and Location B when a fault is detected. An optical fiber is used for communication between the semiconductor circuit breaker 90 and a control device 100A.

The converter A 20 is an example of a power supply device that can supply sufficient current to a fault point when a fault (e.g., ground fault, short circuit, or partial shorting) occurs in a distribution network (including a power network in a load device that receives power supply).

In addition, Location A is provided with the control device 100A, and Location B is provided with a control device 100B. The control device 100A and the control device 100B are connected by an optical network (optical fiber). The optical network used for connection between devices in the present embodiment is not limited to a specific optical network, but is, for example, a power-saving, low-latency, and high-speed optical network such as an IOWN photonic network.

The control device 100A may be a device inside the converter A 20 or a device outside the converter A 20. Alternatively, the control device 100A may be provided outside Location A. The control device 100B may be a device inside the converter B 30 or a device outside the converter B 30. Alternatively, the control device 100B may be provided outside Location B. Instead of providing a control device for each location, it is possible to provide one control device for a plurality of locations.

As illustrated in FIG. 1, a learning device 200 is provided. The learning device 200 may be installed anywhere, and, for example, a virtual machine on a cloud may be used as the learning device 200. The learning device 200 is connected to the control device 100A and the control device 100B via the optical network (optical fiber). Note that the control device 100A or the control device 100B may function as the learning device 200.

In the DC power distribution system according to the present embodiment, a configuration of neutral grounding with high resistance is used in Location A. Specifically, as illustrated in FIG. 1, a resistor 1 and a resistor 2 are provided between the positive distribution line and the negative distribution line between an output of the converter A 20 and a distribution end (boundary between the inside and the outside of Location A), and a neutral point between the resistor 1 and the resistor 2 is grounded to the earth. Each of the resistor 1 and the resistor 2 is, for example, a high resistance of about several MO. The configuration of the neutral grounding with high resistance may be provided inside the converter A 20.

As illustrated in FIG. 1, in Location A, a voltmeter 3 is provided between the positive distribution line (+) and the neutral point, a voltmeter 4 is provided between the negative distribution line (−) and the neutral point, and an ammeter 5 is provided between the neutral point and a grounding point.

In addition, ammeters 6 and 7 are provided on the negative distribution line and the positive distribution line. In addition, a zero-phase current transformer (ZCT) 8 is provided. When imbalance occurs in reciprocating currents in the positive distribution line and the negative distribution line, the zero-phase current transformer 8 measures and outputs a current value generated due to the imbalance.

In addition, in Location B, a voltmeter 9 is provided between the positive distribution line and the negative distribution line between a receiving end (boundary between the outside and the inside of Location B) and the converter B30, and an ammeter 10 is provided on the positive distribution line.

FIG. 1 illustrates an example of arrangement of measuring instruments such as the ammeters and the voltmeters. The number of measuring instruments arranged may be larger than or smaller than that in the arrangement illustrated in FIG. 1. For example, no measuring instrument may be arranged on the Location B side.

### (Connection Configuration Using Optical Fiber)

In Location A illustrated in FIG. 1, optical fibers are used to connect the control device 100A and a voltage conversion unit 20, connect the control device 100A and each voltmeter, connect the control device 100A and each ammeter, and connect the control device 100A and the semiconductor circuit breaker 90. The same applies to the other locations.

In information transmission using an optical fiber, it is possible to allocate a different wavelength (frequency) to each type of information to be transmitted so that various types of information can be instantaneously transmitted and received only with one optical fiber. For example, it is possible to allocate different frequencies to a voltage and a current, or allocate a different frequency to each characteristic waveform. The control device 100A can prevent a fault from spreading by promptly controlling the gate block and the semiconductor circuit breaker 90 via optical fiber on the basis of a result of determination from information acquired via optical fiber.

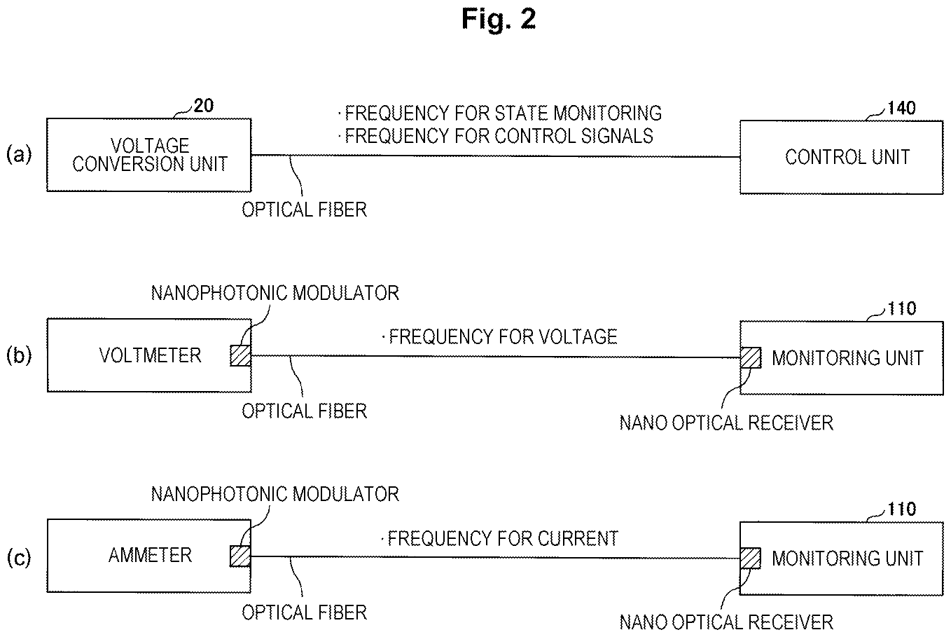

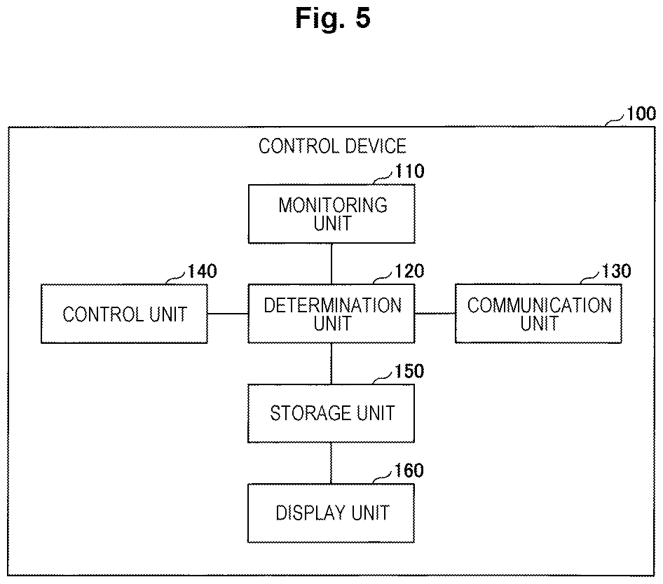

FIG. 2 illustrates a more specific connection configuration example. In FIG. 2, a control unit 140 and a monitoring unit 110 are illustrated as examples of functional units in a control device 100 illustrated in FIG. 5 to be described later. FIG. 2 illustrates an example, and, for example, the monitoring unit in FIG. 2 may be replaced with a determination unit, or the control unit may be replaced with a determination unit.

(a) of FIG. 2 illustrates a configuration in which the voltage conversion unit 20 (including an insulation function, a gate block function, and the like) and the control unit 140 are connected by an optical fiber. For communication of optical signals on the optical fiber, different frequencies, for example, a frequency for state monitoring and a frequency for control signals, are allocated.

(b) of FIG. 2 illustrates a configuration in which a voltmeter and the monitoring unit 110 are connected by an optical fiber. The monitoring unit 110 monitors the voltage obtained by the voltmeter. A frequency for voltage is used for this communication.

The voltmeter is provided with a nanophotonic modulator for E-O conversion, and a nano optical receiver for O-E conversion is provided on the monitoring unit 110 side. A measurement signal (electric signal) of a voltage probe in the voltmeter is directly or indirectly converted into an optical signal by the nanophotonic modulator, and the optical signal is transmitted to the monitoring unit 110. The nanophotonic modulator may be used without the voltage probe.

Both the nanophotonic modulator and the nano optical receiver operate at high speed and high efficiency, thereby achieving energy-saving and high-speed operation. It is therefore possible to perform quick monitoring control with low latency even in a case where the voltmeter and the monitoring unit 110 are located remotely from each other.

(c) of FIG. 2 illustrates a configuration in which an ammeter and the monitoring unit 110 are connected by an optical fiber. The monitoring unit 110 monitors the current obtained by the ammeter. A frequency for current is used for this communication.

The ammeter is provided with a nanophotonic modulator for E-O conversion, and a nano optical receiver for O-E conversion is provided on the monitoring unit 110 side. A measurement signal (electric signal) of a current probe in the ammeter is directly or indirectly converted into an optical signal by the nanophotonic modulator, and the optical signal is transmitted to the monitoring unit 110. The nanophotonic modulator may be used without the current probe. Both the nanophotonic modulator and the nano optical receiver operate at high speed and high efficiency, thereby achieving energy-saving and high-speed operation. It is therefore possible to perform quick monitoring control with low latency even in a case where the ammeter and the monitoring unit 110 are located remotely from each other.

Note that the optical signal from the voltmeter and the optical signal from the ammeter may be multiplexed so that a voltage value (using the frequency for voltage) and a current value (using the frequency for current) can be transmitted to the monitoring unit with one optical fiber.

In addition, as described above, the control device 100 and the learning device 200 are also connected by an optical fiber. For example, in information communication via optical fiber from the control device 100 to the learning device 200, different frequencies may be used for state monitoring information, control signal information, voltage information, and current information so that the information can be transmitted efficiently with one optical fiber.

### (Operation Overview)

Next, an overall operation overview of the DC power distribution system illustrated in FIG. 1 will be described. In Location A, each measuring instrument performs measurement at a short time interval (for example, every several microseconds to several milliseconds), and the control device 100A acquires a measurement result obtained by each measuring instrument. Similarly, in Location B, each measuring instrument performs measurement at a short time interval (for example, measurement every several microseconds to several milliseconds), and the control device 100B acquires a measurement result obtained by each measuring instrument.

While both the control device 100A and the control device 100B are capable of determining an operation state (a fault or an event other than faults such as a load fluctuation) in the DC power distribution system, the determination is performed by the control device 100A in the present embodiment.

In a case where the operation state is determined by the control device 100A, the control device 100B transmits, to the control device 100A via the optical network (optical fiber), the measurement result obtained by each measuring instrument in Location B. The control device 100B also monitors the state of the load device at a short time interval (for example, measurement every several microseconds to several milliseconds), and transmits, to the control device 100A via the optical network (optical fiber), information (equipment information) regarding the state of the load device acquired by the monitoring. By using the optical network, it is possible to perform reliable transmission with low latency, and even in a case where the distance between the locations is long (for example, several kilometers), processing such as fault detection and circuit breaking in the present system can be performed at high speed.

On the basis of measurement results and equipment information acquired in Location A and Location B, the control device 100A determines the operation state such as a ground fault (+ side), a ground fault (− side), a short circuit, a partial shorting, an inrush current, a load connection, ON of load or OFF of load, or a load fluctuation from any one of or two or more (including all) of a voltage value, a current value, a waveform indicating a change in the voltage value, a waveform indicating a change in the current value, the equipment information, and the like.

A short circuit means that the positive distribution line and the negative distribution line are connected with a small resistance, and a partial shorting means that the positive distribution line and the negative distribution line are connected with a large resistance.

The control device 100A displays a determination result. The control device 100A may transmit the determination result to the control device 100B so that the determination result can be displayed also by the control device B.

In a case where a fault such as a ground fault or a short circuit has been detected, the control device 100A can operate the gate block in the converter A20 to stop power distribution by transmitting an abnormal signal to the converter A20 via optical fiber. The control device 100A can also break the circuit between Location A and Location B by transmitting an abnormal signal to the semiconductor circuit breaker 90 connected by the optical fiber. In a case where a fault such as a ground fault or a short circuit has been detected, the control device 100A transmits a determination result or an abnormal signal to the control device 100B, so that the control signal 100B can operate a gate block or the like in Location B.

In addition, it is possible to determine an event that is not a fault, such as an inrush current or a load connection, from a waveform indicating a change in the current value or the voltage value, and the control device 100A can prevent a malfunction such as erroneous stop of power distribution.

In the present embodiment, various signals are transmitted and received via the optical network (optical fiber), and this makes it possible to reduce erroneous detection, without influence of noise generated in a metal wire.

### <Example of Determination Result>

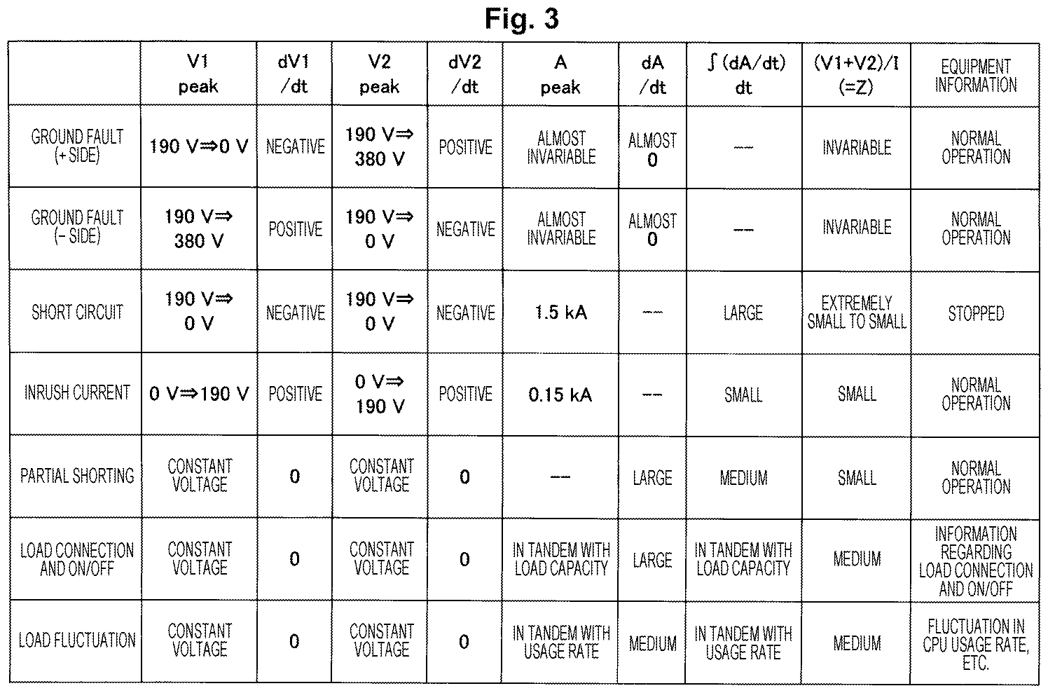

FIG. 3 illustrates an example of detection values and determination results from the measuring instruments. V1 in FIG. 3 represents a detection value of the voltmeter 3 between the neutral point and the positive distribution line, and V2 represents a detection value of the voltmeter 4 between the neutral point and the negative distribution line. A is, for example, a detection value (current value) of the ammeter 7 or the ammeter 6. “Peak” means a maximum value (maximum value of fluctuation in a short time).

dV1/dt is a differential of V1 with respect to time t, and represents a time variation of V1. The same applies to dV2/dt and dA/dt. ∫(dA/dt)dt represents an integral of variations of A.

I in (V1+V2)/I is, for example, a detection value (current value) of the ammeter 7 or the ammeter 6. An impedance Z (which may be referred to as “resistance” in a case where only direct current is considered) is obtained by (V1+V2)/I.

For example, in a case where a fault such as a short circuit occurs in the distribution network between Location A and Location B, the control device 100A can calculate the impedance of the distribution line between Location A (specifically, the measuring instrument) and the fault point by (V1+V2)/I and calculate the distance between Location A and the fault point. That is, the distance can be calculated by dividing the impedance obtained by (V1+V2)/I by the impedance per unit length of the distribution line between Location A and the fault point.

The impedance per unit length of the distribution line is determined by the thickness (cross-sectional area) of the distribution line. In addition, since the thickness (that is, the impedance per unit length of the distribution line) of the distribution line is generally determined by the scale (e.g., distribution between locations or distribution inside the location) of the distribution network, the control device 100A holds in advance, in a storage unit, the impedance per unit length of the distribution line for each scale of the distribution network, and calculates the distance by using the impedance per unit length suitable for the scale of the distribution network to be controlled. The control device 100A may derive impedance including a component of jX (reactance) in a case where a transient phenomenon of current or voltage has been captured.

FIG. 3 illustrates that, for example, in a case where an obtained measurement result corresponds to a voltage waveform in which V1 rapidly becomes 0 and V2 rapidly becomes 380 V, it is determined that a ground fault has occurred in the positive distribution line. Other events are also as illustrated in FIG. 3. More specific determination logic (flow) will be described later.

Each of the control device 100A and the control device 100B may transmit an acquired measurement result and the like to the learning device 200, and the learning device 200 may learn, from either or both of the waveform of the voltage value and the waveform of the current value, a relationship between the waveform and the event.

The method of the learning is not limited to a specific method, and a neural network model may be used, for example. An example of learning an inrush current will be described as an example. First, a large number of waveforms obtained from measurement results of the ammeter when an inrush current occurs in the distribution network are acquired as learning data.

The learning device 200 inputs a waveform of the learning data to a model, and learns a parameter of the model such that the waveform is classified as “inrush current”. Then, the learned model is stored in the control device 100A. The control device 100A can determine whether a waveform of a measurement result corresponds to an inrush current by using the model.

Similarly, each of events such as a ground fault (+ side), a ground fault (− side), a short circuit, a partial shorting, a load connection, ON of load (load input) or OFF of load, and a load fluctuation can be determined by using a model.

The determination of an event (operation state) by using a neural network model as described above is an example.

For example, for each event, a waveform that is representative and observed when the event occurs is prepared as a representative waveform and stored in a storage unit of the control device 100A. The control device 100A can compare a detected waveform with the representative waveform of each event and determine that the event of the representative waveform close to the detected waveform has occurred. In the comparison between the detected waveform and the representative waveform of each event, for example, any one of or two or more (including all) of a plurality of feature amounts (e.g., an inclination, a time length from a start of a change to an end of the change, and a magnitude of the change (a difference between a value before the change and a value after the change) may be compared between the observed waveform and the representative waveform, and whether the detected waveform and the representative waveform are close to each other may be determined on the basis of whether the difference in each feature amount is smaller than a threshold.

### System Configuration Example 2

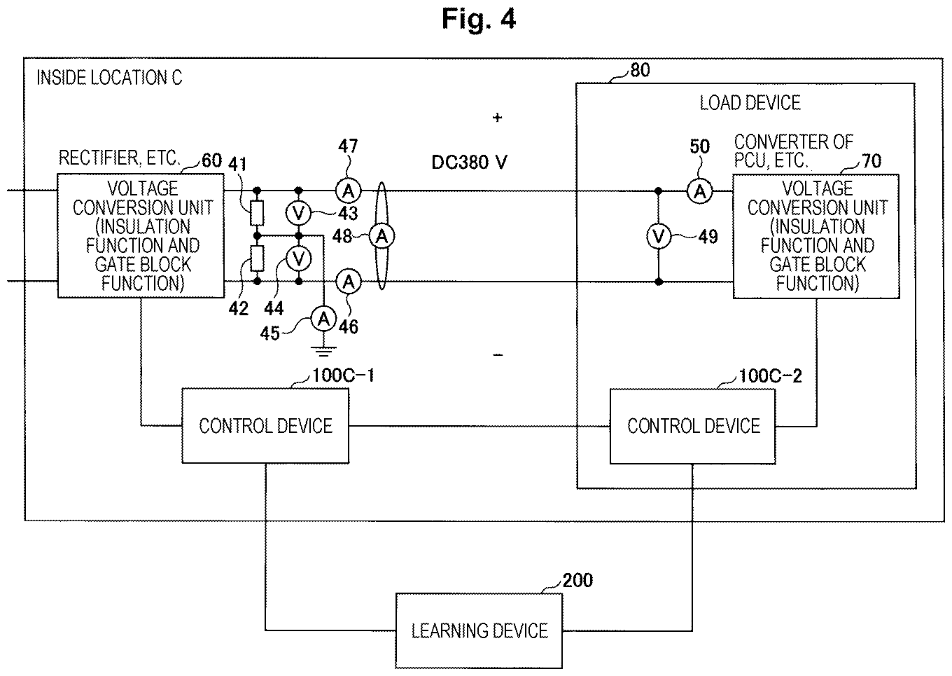

FIG. 4 illustrates Configuration Example 2 of the DC power distribution system according to the present embodiment. Configuration Example 2 shows a system that performs power distribution (power feeding) from a power supply device such as a rectifier 60 to a load device 80 inside Location C. Examples of Location C include buildings such as a communication building, but are not limited to buildings.

Configuration Example 2 differs from Configuration Example 1 only in scale, and the basic configurations of Configuration Example 1 and Configuration Example 2 are the same. In Configuration Example 2, as in Configuration Example 1, optical fibers are used to connect control devices, connect the control device and a learning device, and connect the control device and ammeters and voltmeters. In addition, nanophotonic modulators are used for ammeters and voltmeters, and nano optical receivers are used on the side of a monitoring unit that monitors signals of the ammeters and voltmeters.

The rectifier 60 converts alternating current from a commercial power supply into direct current, and outputs power of the direct current. Similarly to the converter A20 in Configuration Example 1, the rectifier 60 includes a voltage conversion unit, and has an insulation function and a gate block function. The load device 80 is, for example, a device such as a server, and there is a converter 70 inside the load device. The converter 70 includes a voltage conversion unit, and has an insulation function and a gate block function. As in Configuration Example 1, the rectifier 60 has a configuration of high-resistance neutral grounding, and includes measuring instruments such as a voltmeter, an ammeter, and a zero-phase current transformer.

In addition, similarly to the control device 100A, the control device 100B, and the learning device 200 in Configuration Example 1, a control device 100C-1, a control device 100C-2, and the learning device 200 are provided. Here, the control device 100C-2 is a functional unit inside the load device 80. The operation in Configuration Example 2 is similar to the operation in Configuration Example 1.

### (Configuration Example of Control Device 100)

A configuration example of the control device 100A and the control device 100B in the DC power distribution system illustrated in FIG. 1 will be described as an example. Here, as an example, it is assumed that the control device 100A performs determination processing and the control device 100B does not perform determination processing.

FIG. 5 illustrates a configuration example of the control device 100A. As illustrated in FIG. 5, the control device 100A includes the monitoring unit 110, a determination unit 120, a communication unit 130, the control unit 140, a storage unit 150, and a display unit 160. The units are connected as illustrated in the drawing. Connection lines are, for example, optical fibers.

The monitoring unit 110 acquires measurement results obtained by the measuring instruments (e.g., voltmeters and ammeters) in Location A via optical fiber, and inputs the acquired measurement results to the determination unit 120. Alternatively, the determination unit 120 may acquire measurement results obtained by the measuring instruments (e.g., voltmeters and ammeters) in Location A via optical fiber. The monitoring unit 110 can also acquire equipment information (e.g., information regarding the converter A20) in Location A via optical fiber.

The communication unit 130 communicates with another control device 100 and the learning device 200 via optical fiber. More specifically, the communication unit 130 receives the measurement results and the equipment information from the control device 100B in Location B, and inputs them to the determination unit 120.

The determination unit 120 determines the operation state such as a ground fault (+ side), a ground fault (− side), a short circuit, a partial shorting, an inrush current, a load connection, ON of load or OFF of load, and a load fluctuation on the basis of the measurement results input from the monitoring unit 110 and the information input from the communication unit 130.

The storage unit 150 stores, for example, a threshold necessary for the determination. Furthermore, in a case where the above-described model is used for the determination, the model (specifically, learned parameter) is stored in the storage unit 150, and the determination unit 120 reads the model from the storage unit 150 and uses the model for determination.

In addition, the determination unit 120 may store, in the storage unit 150, a determination result of the operation state such as a ground fault (+ side), a ground fault (− side), a short circuit, a partial shorting, an inrush current, a load connection, ON of load or OFF of load, and a load fluctuation, and the waveform of the voltage value, the waveform of the current value, or both the waveform of the voltage value and the waveform of the current value corresponding to the determination result. The stored data (data of a set of a determination result and a waveform) can be used as learning data in the learning device 200. The control device 100A may have a learning function, without the learning device 200 being included.

In a case where the determination result is a fault such as a ground fault or a short circuit, the control unit 140 transmits an abnormal signal for operating the gate block to the converter A20 via optical fiber. Alternatively, the abnormal signal may be transmitted to the semiconductor circuit breaker 90 via optical fiber. The display unit 160 displays the determination result and the like.

In a case where each of the units 110 to 160 illustrated in FIG. 5 has a determination function and a fault or the like can be determined only by the determination function, a result of the determination may be preferentially used.

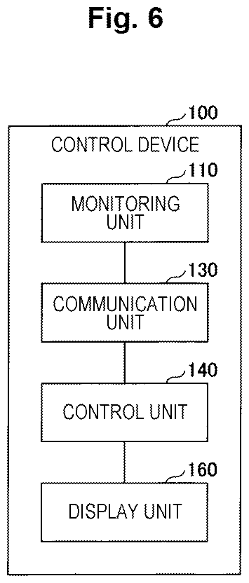

FIG. 6 is a diagram illustrating a configuration example of the control device 100B in Location B. As illustrated in FIG. 6, the control device 100B includes the monitoring unit 110, the communication unit 130, the control unit 140, and the display unit 160.

The monitoring unit 110 acquires, via optical fiber, measurement results measured by the measuring instruments in Location B, and acquires, via optical fiber, equipment information of the load device in Location B. The communication unit 130 transmits the measurement results and the equipment information acquired by the monitoring unit 110 to the control device 100A in Location A via optical fiber.

In the control device 100A, determination processing is executed, and a result of the determination is transmitted to the control device 100B in Location B via optical fiber. For example, in a case where the determination result indicates that a fault has occurred, the control unit 140 outputs an abnormal signal for operating the gate block in Location B. The display unit 160 outputs information indicating that a fault has occurred. Alternatively, the abnormal signal may be transmitted from the control device 100A to the control device 100B in Location B.

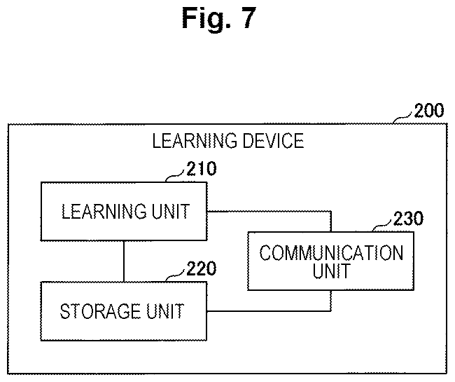

FIG. 7 is a diagram illustrating a configuration example of the learning device 200. As illustrated in FIG. 7, the learning device 200 includes a learning unit 210, a storage unit 220, and a communication unit 230. The communication unit 230 receives learning data (e.g., data of a set of an event and a waveform) from the control devices 100A and 100B and the like via optical fiber, and stores the learning data in the storage unit 220. The learning unit 210 performs learning by using the learning data. For example, as described above, a neural network model is learned. The communication unit 230 transmits the learned model to the control device 100A or the like.

### <Hardware Configuration Example>

Each of the control devices 100A, 100B, 100C-1, and 100C-2 and the learning device 200 may have a configuration in which each component is an independent device and the components are connected by optical fiber, or may be a device configured by causing a computer to execute a program. This computer may be a physical computer, or may be a virtual machine.

That is, the device (the control devices 100A, 100B, 100C-1, and 100C-2 and the learning device 200) can be implemented by executing a program corresponding to the processing to be performed in the device, using hardware resources such as a CPU and a memory installed in the computer. The above program can be stored and distributed by being recorded in a computer-readable recording medium (e.g. portable memory). Furthermore, the above program can also be provided through a network such as the Internet or an electronic mail.

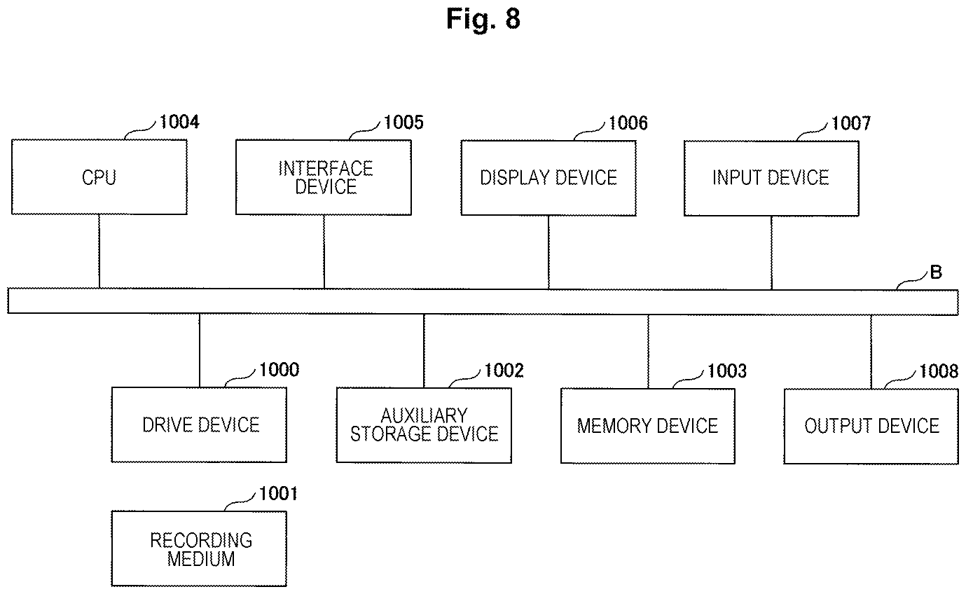

FIG. 8 is a diagram illustrating a hardware configuration example of the above computer. The computer in FIG. 8 includes a drive device 1000, an auxiliary storage device 1002, a memory device 1003, a CPU 1004, an interface device 1005, a display device 1006, an input device 1007, an output device 1008, and the like which are connected to each other by a bus BS.

The program for implementing the processing in the computer is provided by a recording medium 1001 such as a CD-ROM or a memory card. When the recording medium 1001 storing the program is set in the drive device 1000, the program is installed on the auxiliary storage device 1002 from the recording medium 1001 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is given, the memory device 1003 reads and stores the program from the auxiliary storage device 1002. The CPU 1004 implements a function related to the device in accordance with a program stored in the memory device 1003. The interface device 1005 is used as an interface for connecting to a network, and functions as a transmission unit and a reception unit. The display device 1006 displays a graphical user interface (GUI) or the like by the program. The input device 1007 includes a keyboard and mouse, buttons, a touch panel, or the like, and is used to input various operation instructions. The output device 1008 outputs a calculation result.

### (Operation Flow)

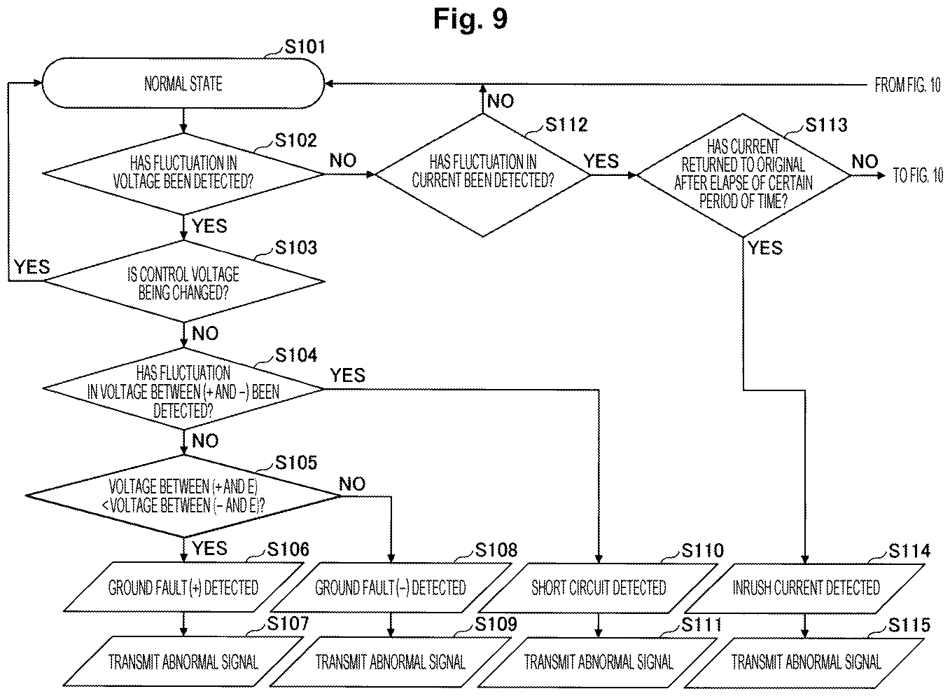

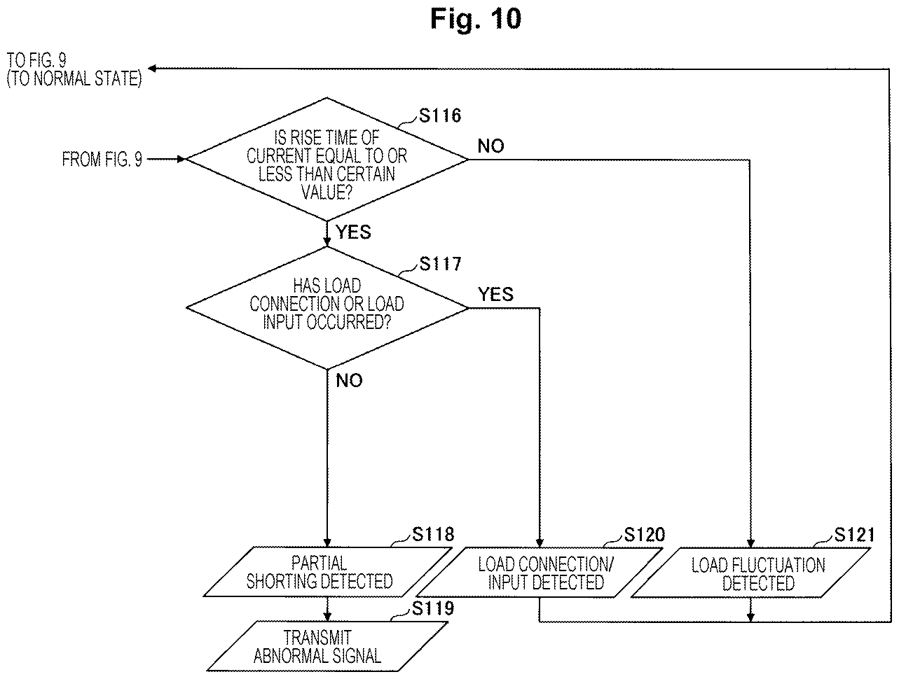

Next, a detailed operation example of the control device 100A will be described with reference to flowcharts in FIGS. 9 and 10. The operation illustrated in the flowcharts in FIGS. 9 and 10 is executed by the determination unit 120 of the control device 100A. Monitoring targets assumed in the flowcharts in FIGS. 9 and 10 are V1, which is a voltage between the positive distribution line and the neutral point (earth), V2, which is a voltage between the negative distribution line and the neutral point (earth), V1+V2=V, which is a voltage between the positive distribution line and the negative distribution line, and a current flowing through the distribution line (for example, a current measured by the ammeter 7 illustrated in FIG. 1).

In S101, the determination unit 120 detects no fluctuation in any of V1, V2, V, and the current, and thus the DC power distribution system is in a normal state.

In S102, the determination unit 120 determines whether a fluctuation in the voltage (V1, V2, or V) has been detected. If a fluctuation has been detected, the processing proceeds to S103, and if no fluctuation has been detected, the processing proceeds to S112. Note that “detection of a fluctuation in the voltage” means, for example, detecting that the value of the voltage at time t+Δt has changed by a threshold or more as compared with the value of the voltage at time t. The same applies to “detection of a fluctuation in the current”.

If a fluctuation in the voltage has been detected (Yes in S102), the determination unit 120 determines in S103 whether a control voltage is being changed on the basis of information regarding the state of the converter A20. In a case where a floating charged storage battery is connected to the target DC power distribution system, it is determined whether “(the control voltage is being changed) and (the storage battery is not being discharged)” in the determination in S103. If the result of determination in S103 is Yes, the processing returns to S101, and if No, the processing proceeds to S104.

In S104, if the detected fluctuation in the voltage is a fluctuation of V (=V1+V2), the processing proceeds to S110, and if the detected fluctuation in the voltage is not a fluctuation of V (=V1+V2), the processing proceeds to S105.

In S105, the determination unit 120 determines whether “V1<V2” holds. If “V1<V2” holds, the processing proceeds to S106, and if “V1<V2” does not hold, the processing proceeds to S108.

If “V1<V2” holds, in S106, the detection unit 120 determines that a ground fault has occurred in the positive distribution line. In a case where a ground fault has occurred in the positive distribution line, the positive distribution line is grounded via a ground fault resistance (low resistance), so that the voltage across the resistor 1 on the positive side decreases and the voltage across the resistor 2 on the negative side increases, and “V1<V2” holds. In step S107, the control unit 140 that has received a notification of ground fault detection from the determination unit 120 transmits an abnormal signal.

If the result of determination in S105 is No, that is, if “V1<V2” does not hold, the detection unit 120 determines in S108 that a ground fault has occurred in the negative distribution line. In a case where a ground fault has occurred in the negative distribution line, the negative distribution line is grounded via a ground fault resistance (low resistance), so that the voltage across the resistor 2 on the negative side decreases and the voltage across the resistor 1 on the positive side increases, and “V1>V2” holds. In step S109, the control unit 140 that has received a notification of ground fault detection from the determination unit 120 transmits an abnormal signal.

If the result of determination in S104 is Yes, that is, if a fluctuation in V has been detected, the determination unit 120 determines in S110 that a short circuit has occurred. In step S111, the control unit 140 that has received a notification of ground fault detection from the determination unit 120 transmits an abnormal signal.

If the result of determination in S102 is No (that is, if no fluctuation in the voltage has been detected), the determination unit 120 determines in S112 whether there has been a fluctuation in the current, and the processing proceeds to S113 if there has been a fluctuation in the current.

In S113, the determination unit 120 determines whether the value of the current has returned to the value before the fluctuation after a lapse of a predetermined time from the occurrence of the fluctuation in the current. If the determination result is No, the processing proceeds to S116. If the determination result is Yes, the processing proceeds to S114, and the determination unit 120 determines that an inrush current has occurred. In S115, the control unit 140 that has received a notification of inrush current detection from the determination unit 120 transmits an abnormal signal. Note that an inrush current may be regarded as being in a normal state, and the abnormal signal may not be transmitted.

If the result of determination in S113 is No, that is, if the current has not returned to the original state after a certain period of time has elapsed, the processing proceeds to S116 in FIG. 10.

In S116, the determination unit 120 determines whether a rise time of the current is equal to or less than a threshold. If the determination unit 120 has determined that the rise time of the current is equal to or less than the threshold, the processing proceeds to S117.

In S117, the determination unit 120 determines whether load connection or load input has occurred at the time of the current rise on the basis of equipment information received from Location B.

If the determination result in S117 is No, the determination unit 120 determines in S118 that a partial shorting has occurred. In S119, the control unit 140 that has received a notification of partial shorting detection from the determination unit 120 transmits an abnormal signal.

If the result of determination in S117 is Yes, that is, if load connection or load input has occurred, the processing proceeds to S120, and the determination unit 120 determines that load connection or load input has occurred, and the processing returns to S101.

If the result of determination in S116 is No, that is, if the rise time of the current is not equal to or less than the threshold, the processing proceeds to S121, and the determination unit 120 determines that a load fluctuation has occurred, and the processing returns to S101.

### (Determination Based on Waveform)

In the determination of each event illustrated in FIGS. 9 and 10, more specifically, the determination unit 120 performs the determination on the basis of the waveform corresponding to the event. The “waveform” used in the determination may be a waveform itself (that is, the value at each time), or a feature amount such as an inclination (differential) or a change time length may be used as the “waveform”.

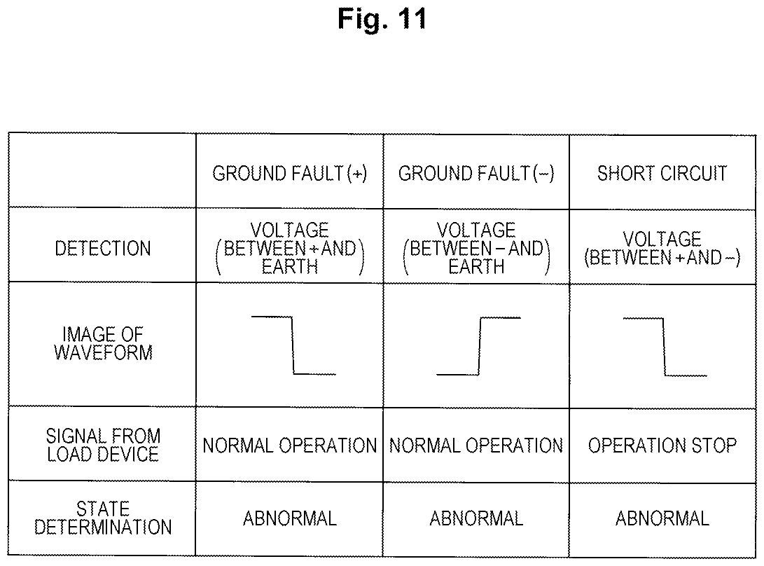

FIG. 11 is a diagram illustrating images of waveforms, each of the waveforms corresponding to one of a ground fault (+), a ground fault (−), and a short circuit in a case of Yes in S102 in the flow in FIG. 9 (in a case where there has been a fluctuation in the voltage).

As illustrated in FIG. 11, in a case where a waveform detected between the positive distribution line and the earth shows that a potential of the positive distribution line rapidly decreases and becomes close to 0 V, it is determined that a ground fault (+) has occurred. In a case where a waveform detected between the negative distribution line and the earth shows that a potential of the negative distribution line rapidly increases and becomes close to 0 V, it is determined that a ground fault (−) has occurred. The determination in S105 in FIG. 9 may be determination of whether the change in voltage corresponds to a waveform having such a characteristic.

In addition, when a waveform in which the voltage between the positive distribution line and the negative distribution line rapidly decreases is detected, it is determined that a short circuit has occurred.

FIG. 11 illustrates a signal from the load device when each event occurs. By knowing that the load device is operating normally in the event of a “ground fault (+)” or a “ground fault (−)”, it is possible to more accurately determine that the fluctuation in the voltage has been caused by a ground fault.

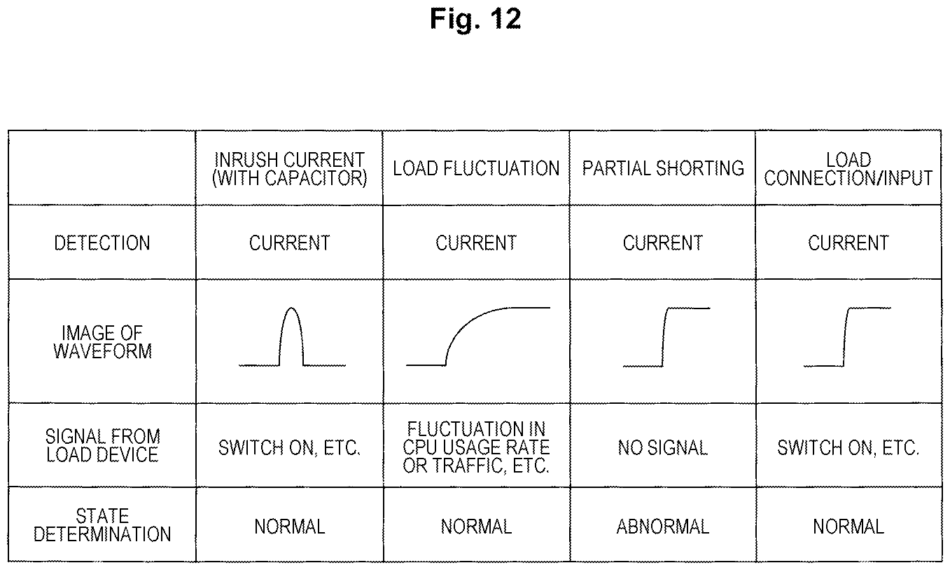

FIG. 12 is a diagram illustrating images of waveforms, each of the waveforms corresponding to one of an inrush current, a load fluctuation, a partial shorting, and a load connection or load input in a case where there has been a fluctuation in the current in a case of No in S102 (in a case where there has been no fluctuation in the voltage) in the flow in FIG. 9.

As illustrated in FIG. 12, the waveform of the current when an inrush current occurs is such that the value of the current increases and then immediately returns to the original state. Step S113 in FIG. 9 corresponds to determination of whether the change in the measured current value corresponds to a waveform having such a characteristic.

The waveform of the current when a load fluctuation occurs is such that the value of the current gradually increases and does not immediately return to the original value. Step S116 in FIG. 10 corresponds to determination of whether the change in the measured current value corresponds to a waveform having such a characteristic.

The waveform of a partial shorting and the waveform of a load connection or input are similar to each other, and the waveforms are such that the current rapidly increases. However, in the case of a partial shorting, a special signal (e.g., switch ON) is not obtained from the load device, but in a case of a load connection or input, a signal such as switch ON is obtained from the load device. That is, a partial shorting and a load connection or input can be identified by the waveform and the equipment information. S116 and S117 in FIG. 10 correspond to determination based on the waveform and the equipment information.

### Effects of Embodiment

As described above, with the technology according to the present embodiment, it is possible to accurately detect a fault that has occurred in the DC power distribution system while avoiding erroneous determination of an event such as a load fluctuation as a fault.

In addition, signals are transmitted and received via optical fiber, and this allows for reducing erroneous detection, without influence of noise generated in the metal wire. In addition, a nanophotonic modulator is used for E-O conversion in the voltmeters and ammeters and a nano optical receiver is used for O-E conversion on the information acquisition side, and this allows for power-saving and low-loss monitoring control with high-speed operation (operation with low latency). It is also possible to perform monitoring control with low latency even between remote locations several kilometers or more away from each other.

### Summary of Embodiment

The present specification discloses at least a DC power distribution system, a control device, an operation state determination method, and a program described in the following clauses.

### (Clause 1)

A DC power distribution system that distributes power from a power supply device to a load device via a distribution network, the DC power distribution system including:
a measuring instrument that is provided in the distribution network; and
a control device that includes a determination unit that acquires, through optical fiber, a voltage value and a current value measured by the measuring instrument, and determines an operation state in the DC power distribution system on the basis of a waveform indicating a change in the voltage value and a waveform indicating a change in the current value.

### (Clause 2)

The DC power distribution system according to Clause 1, in which
the control device includes:
a control unit that stops power distribution from the power supply device by operating a gate block or a circuit breaker through optical fiber in a case where the determination unit determines that a fault has occurred in the distribution network.

### (Clause 3)

The DC power distribution system according to Clause 1 or 2, in which
the measuring instrument includes a nanophotonic modulator that converts a measurement value of an electric signal into an optical signal to be transmitted through optical fiber.

### (Clause 4)

The DC power distribution system according to any one of Clauses 1 to 3, in which
a different frequency is used for each type of information to be transmitted through the optical fiber.

### (Clause 5)

An operation state determination method in a DC power distribution system that distributes power from a power supply device to a load device via a distribution network, the operation state determination method including:
a step of measuring, by a measuring instrument provided in the distribution network, a voltage value and a current value. and
a step of acquiring, through optical fiber, the voltage value and the current value measured by the measuring instrument, and determining an operation state in the DC power distribution system on the basis of a waveform indicating a change in the voltage value and a waveform indicating a change in the current value.

### (Clause 6)

A control device used in a DC power distribution system that distributes power from a power supply device to a load device via a distribution network, the control device including:
a determination unit that acquires, through optical fiber, a voltage value and a current value measured by a measuring instrument provided in the distribution network, and determines an operation state in the DC power distribution system on the basis of a waveform indicating a change in the voltage value and a waveform indicating a change in the current value.

### (Clause 7)

A program for causing a computer to function as the control device according to Clause 6.

While the present embodiment has been described above, the present invention is not limited to such a specific embodiment, and various modifications and changes can be made within the scope of the gist of the present invention described in the claims.

### REFERENCE SIGNS LIST

1, 2, 1, 42 Resistor
3, 4, 9, 43, 44, 49 Voltmeter
6, 7, 8, 10, 46, 47, 48, 50 Ammeter
20, 30, 70 Converter
80 Load device
90 Semiconductor circuit breaker
100 Control device
110 Monitoring unit
120 Determination unit
130 Communication unit
140 Control unit
150 Storage unit
160 Display unit
200 Learning device
210 Learning unit
220 Storage unit
230 Communication unit
80 Load device
1000 Drive device
1001 Recording medium
1002 Auxiliary storage device
1003 Memory device
1004 CPU
1005 Interface device
1006 Display device
1007 Input unit

1. A DC power distribution system to distribute power from a power supply device to a load device via a distribution network, the DC power distribution system comprising:
a measuring instrument provided in the distribution network; and
a control device including circuitry configured to
acquire, through an optical fiber, a voltage magnitude, and a current magnitude, measured by the measuring instrument, the voltage magnitude and the current magnitude being related to the distribution network, and
determine an operation state of the DC power distribution system, based on a waveform indicating a change in the voltage magnitude and a waveform indicating a change in the current magnitude.

2. The DC power distribution system according to claim 1, wherein the circuitry is configured to
determine whether a fault has occurred in the distribution network, and
operate a gate block or a circuit breaker through the optical fiber, upon determining that the fault has occurs in the distribution network, to stop power distribution from the power supply device.

3. The DC power distribution system according to claim 1, wherein the measuring instrument includes a nanophotonic modulator configured to convert a measurement value of an electric signal into an optical signal to be transmitted through the optical fiber.

4. The DC power distribution system according to claim 1, wherein a different frequency is configured to be used for each type of information to be transmitted through the optical fiber.

5. An operation state determination method in a DC power distribution system that distributes power from a power supply device to a load device via a distribution network, the operation state determination method comprising:
measuring, by a measuring instrument provided in the distribution network, a voltage magnitude and a current magnitude, the voltage magnitude and the current magnitude being related to the distribution network;
acquiring, through an optical fiber, the voltage magnitude, and the current magnitude, measured by the measuring instrument; and
determining an operation state of the DC power distribution system, based on a waveform indicating a change in the voltage magnitude and a waveform indicating a change in the current magnitude.

6. A control device used in a DC power distribution system to distribute power from a power supply device to a load device via a distribution network, the control device comprising:
circuitry configured to
acquire, through an optical fiber, a voltage magnitude, and a current magnitude, measured by a measuring instrument provided in the distribution network, and
determine an operation state of the DC power distribution system, based on a waveform indicating a change in the voltage magnitude and a waveform indicating a change in the current magnitude.

7. A non-transitory computer readable medium storing a program for causing a computer to execute the operation state determination method of claim 5.
